(19) United States
(12) Patent Application Publication
(10) Pub. No.: US 2025/0008210 A1
(43) Pub. Date: Jan. 2, 2025

(54) RECORDING METHOD, RECORDING DEVICE, AND PROGRAM

(71) Applicant: FUJIFILM Corporation, Tokyo (JP)

(72) Inventors: Kei YAMAJI, Saitama-shi (JP); Toshiki KOBAYASHI, Saitama-shi (JP); Masaru KOBAYASHI, Saitama-shi (JP)

(73) Assignee: FUJIFILM Corporation, Tokyo (JP)

(21) Appl. No.: 18/886,529

(22) Filed: Sep. 16, 2024

Related U.S. Application Data
(63) Continuation of application No. PCT/JP2022/048142, filed on Dec. 27, 2022.

(30) Foreign Application Priority Data
Mar. 30, 2022 (JP) 2022-056193

(51) Int. Cl. H04N 23/611; H04N 5/91; H04N 23/62; H04N 23/67

(52) U.S. Cl. CPC H04N 23/611; H04N 5/91; H04N 23/62; H04N 23/67

(57) ABSTRACT

There are provided a recording method, a recording device, and a program for appropriately recording accessory information according to a subject in image data.

According to the present invention, there is provided a recording method of recording accessory information in a frame of moving image data including a plurality of frames, the recording method including: a recognition step of recognizing a plurality of recognition subjects in the plurality of frames; a search step of searching for the accessory information which is able to be recorded for search subjects based on search items, the search subjects being at least some of the plurality of recognition subjects; a setting step of setting the search items different from each other for each of the search subjects in a case where a plurality of the search subjects are present; and a recording step of recording at least some of the search items as the accessory information based on a result of the search step.

### CROSS-REFERENCE TO RELATED APPLICATIONS

This application is a Continuation of PCT International Application No. PCT/JP2022/048142 filed on Dec. 27, 2022, which claims priority under 35 U.S.C. § 119(a) to Japanese Patent Application No. 2022-056193 filed on Mar. 30, 2022. The above applications are hereby expressly incorporated by reference, in their entirety, into the present application.

### BACKGROUND OF THE INVENTION

### 1. Field of the Invention

The present invention relates to a recording method, a recording device, and a program.

### 2. Description of the Related Art

Accessory information related to a subject in data may be recorded in image data such as moving image data and still image data. By recording such accessory information, it is possible to specify a subject in image data and then use the image data.

For example, in the invention described in JP1993-309381A (JP-H6-309381A), at least one keyword is assigned to each scene of a moving image based on an operation of a user, and the keyword assigned to each scene is recorded together with the moving image data.

### SUMMARY OF THE INVENTION

In a case of adding the accessory information related to the subject in the image data, it is necessary to search information suitable for the subject (for example, information that matches a feature of the subject). In this case, it is required to efficiently search for the accessory information according to the subject.

On the other hand, the subject in the image data may be changed according to an imaging scene, a direction of the image capturing device, or the like. In this case, it is necessary to search for the accessory information corresponding to the changed subject.

One embodiment of the present invention has been made in view of the above circumstances, and an object of the present invention is to provide a recording method, a recording device, and a program for solving the problems in the related art and appropriately recording accessory information corresponding to a subject in image data.

In order to achieve the above object, according to the present invention, there is provided a recording method of recording accessory information in a frame of moving image data including a plurality of frames, the recording method comprising a recognition step of recognizing a plurality of recognition subjects in the plurality of frames, a search step of searching for the accessory information which is able to be recorded for search subjects based on search items, the search subjects being at least some of the plurality of recognition subjects, a setting step of setting the search items different from each other for each of the search subjects in a case where a plurality of the search subjects are present, and a recording step of recording at least some of the search items as the accessory information based on a result of the search step.

Further, the search step may be executed for the search subject selected by a predetermined condition.

Further, in the configuration, the condition may be a condition based on image quality information or size information of the search subject in the frame.

Further, in the configuration, the condition may be a condition based on a focusing position which is set by a recording device that records the moving image data or a visual line position of a user during recording of the moving image data.

Further, in the recording step, coordinate information of the focusing position or the visual line position may be recorded in the frame as the accessory information.

Further, in the search step, the search item selected by the user may be used.

Further, in the setting step, priorities for the search subjects may be set for each of the search subjects. In this case, an accuracy of the search item which is set for the search subject having a higher priority may be higher than an accuracy of the search item which is set for the search subject having a lower priority.

Further, in the setting step, an accuracy of the search item may be set according to a result of the search step that is executed in the past.

Further, the search subject in a first frame may be present in a second frame before the first frame among the plurality of frames. In this case, in the setting step, the accuracy of the search item that is set for the search subject in the first frame may be set to be higher than the accuracy of the search item that is set for the search subject in the second frame.

Further, the recording method according to the present invention may further comprise: a receiving step of receiving an input of a user that is related to an item of the accessory information. In this case, the recording step may be executed to record the accessory information corresponding to the input item in an input frame corresponding to the input of the user, among the plurality of frames.

Further, in the receiving step, an item of the accessory information may be able to be received, the item being different from the search item which is set in the setting step.

Further, the accessory information may be stored in a data file different from the moving image data.

Further, according to an embodiment of the present invention, there is provided a recording device that records accessory information in a frame of moving image data including a plurality of frames, the recording device comprising a processor. Further, the processor is configured to execute: recognition processing of recognizing a plurality of recognition subjects in the plurality of frames; search processing of searching for the accessory information which is able to be recorded for search subjects based on search items, the search subjects being at least some of the plurality of recognition subjects; setting processing of setting the search items different from each other for each of the search subjects in a case where a plurality of the search subjects are present; and recording processing of recording at least some of the search items as the accessory information based on a result of the search processing.

Further, according to an embodiment of the present invention, there is provided a program causing a computer to execute each of the recognition step, the search step, the setting step, and the recording step included in the recording method.

According to an embodiment of the present invention, there is provided a recording method of recording accessory information in moving image data, the recording method comprising: a recognition step of recognizing a plurality of recognition subjects in the image data; a search step of searching for the accessory information which is able to be recorded for search subjects based on search items, the search subjects being at least some of the plurality of recognition subjects; a setting step of setting the search items different from each other for each of the search subjects in a case where a plurality of the search subjects are present; and a recording step of recording at least some of the search items as the accessory information based on a result of the search step.

### BRIEF DESCRIPTION OF THE DRAWINGS

FIG. 1 is an explanatory diagram of moving image data.

FIG. 2 is a diagram illustrating accessory information related to a subject in a frame.

FIG. 3 is a diagram illustrating an example of accessory information having a hierarchical structure.

FIG. 4 is a diagram related to a procedure of specifying a position of a subject region having a circular shape.

FIG. 5 is a diagram related to a procedure of recording accessory information in a frame.

FIG. 6 is an explanatory diagram of search items.

FIG. 7 is a diagram illustrating a situation where a subject in a frame is changed during recording of moving image data.

FIG. 8 is a diagram illustrating a hardware configuration of a recording device according to an embodiment of the present invention.

FIG. 9 is an explanatory diagram illustrating functions of the recording device according to the embodiment of the present invention.

FIG. 10 is a diagram illustrating a relationship between a priority for a search subject and a search item.

FIG. 11 is an explanatory diagram of an accuracy of a search item that is set for a search subject in a first frame and a second frame.

FIG. 12 is a diagram illustrating a situation where an accuracy of a search item is gradually increased.

FIG. 13 is a diagram illustrating an execution rate of a search step in a case where a search item selected by a selection unit is used and in a case where a search item set by a setting unit is used.

FIG. 14 is a diagram illustrating a recording flow according to the embodiment of the present invention.

FIG. 15 is a diagram illustrating an example in which accessory information is stored in a data file different from moving image data.

### DESCRIPTION OF THE PREFERRED EMBODIMENTS

Hereinafter, a specific embodiment of the present invention will be described. It should be noted that the embodiment to be described below is merely an example for facilitating understanding of the present invention and does not limit the present invention. The present invention may be modified or improved from the embodiment to be described below without departing from the spirit of the present invention. In addition, the present invention includes equivalents thereof.

In the present specification, the concept of “device” includes a single device that exerts a specific function, and includes a combination of a plurality of devices that are distributed and present independently of each other and exert a specific function in cooperation (coordination) with each other.

In addition, in the present specification, a “person” means an agent that performs a specific action, and its concept includes an individual, a group, a corporation such as a company, and an organization and may further include a computer and a device constituting artificial intelligence (AI). The artificial intelligence implements intellectual functions such as reasoning, prediction, and determination using hardware resources and software resources. The artificial intelligence may use any algorithm such as, for example, an expert system, case-based reasoning (CBR), a Bayesian network, or a subsumption architecture.

### Embodiment of Present Invention

An embodiment of the present invention relates to a recording method, a recording device, and a program that record accessory information in a frame of moving image data.

### Moving Image Data and Frame

The moving image data is created by a well-known moving image capturing device (hereinafter, referred to as an image capturing device), such as a video camera or a digital camera. The image capturing device generates analog image data (RAW image data) by capturing an image of a subject within an angle of view under preset exposure conditions at a constant frame rate (the number of frame images captured in a unit time). Thereafter, the image capturing device creates a frame (specifically, data of a frame image) by performing a correction process, such as γ correction, on digital image data converted from the analog image data.

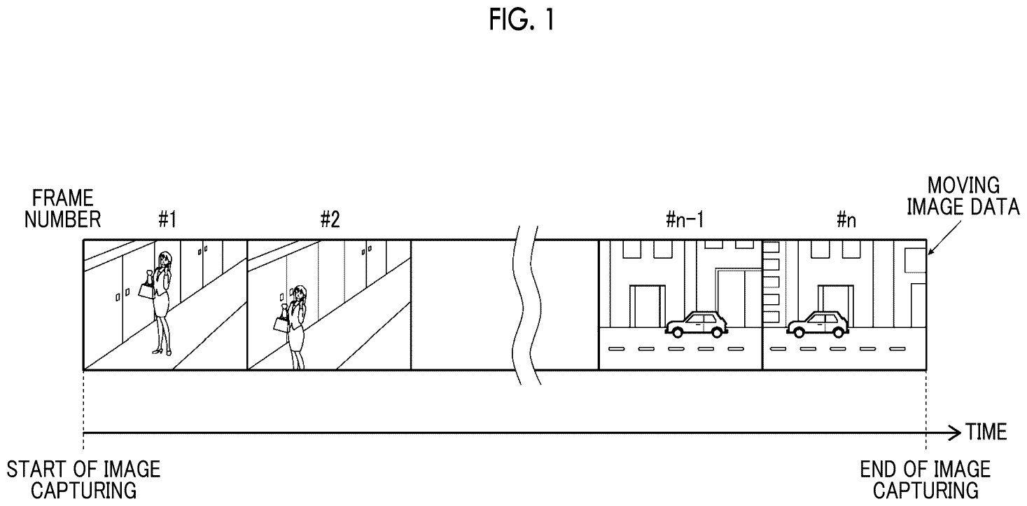

In addition, in a case where the image capturing device records the data of the frame image at a certain rate (interval), as illustrated in FIG. 1, moving image data including a plurality of frames is created.

One or more subjects are included in each frame of the moving image data, that is, one or more subjects are present within the angle of view of each frame. The subject is a person, an object, a background, and the like that are present within the angle of view. In addition, in the present specification, the subject is interpreted in a broad sense, and is not limited to a specific object, and may include a landscape (scenery), a scene such as dawn and night, an event such as a trip and a wedding ceremony, a theme such as cooking and a hobby, and a pattern or a design.

The moving image data has a file format corresponding to the data structure. The file format includes a file format corresponding to a codec (compression technology) of the moving image data and version information. Examples of the file format include moving picture experts group (MPEG)-4, H.264, motion JPEG (MJPEG), high efficiency image file format (HEIF), audio video interleave (AVI), QuickTime file format (MOV), Windows media video (WMV), and flash video (FLV). MJPEG is a file format in which frame images included in a moving image are images in a joint photographic experts group (JPEG) format.

The file format is reflected in the data structure of each frame. In the embodiment of the present invention, the head data in the data structure of each frame starts from a marker segment of a start of image (SOI) or a bitmap file header which is header information. The information includes, for example, information indicating a frame number (consecutive number assigned in order from a frame at a start of image capturing).

In addition, the data structure of each frame includes data of the frame image. The data of the frame image indicates a resolution of the frame image recorded at the angle of view when performing image capturing, a gradation value of two colors of black and white or three colors of red, green, and blue (RGB) which are defined for each pixel, and the like. The angle of view is a range for data processing when the image is displayed or drawn, and the range is defined in a two-dimensional coordinate space having two axes orthogonal to each other as coordinate axes.

In addition, the data structure of each frame may include a region in which the accessory information can be recorded (written). The accessory information is tag information related to each frame and a subject in each frame.

In a case where the moving image file format is, for example, HEIF, accessory information in an exchangeable image file format (Exif) corresponding to each frame, specifically, information related to an imaging date and time, an imaging location, imaging conditions, and the like can be stored. The imaging condition includes a type of the image capturing device that is used, an exposure condition such as an ISO sensitivity, an f-number, and a shutter speed, and a content of image processing. The content of the image processing includes a name and a feature of the image processing that is executed on the image data of the frame, a device that executes the image processing, a region in the angle of view in which the image processing is executed, and the like.

In addition, in a moving image data file, coordinate information of a focusing position (focus point) during recording of the moving image data or coordinate information of a visual line position of the user (the visual line position will be described later) can be recorded as the accessory information. The coordinate information is information indicating coordinates of the focusing position or the visual line position in a two-dimensional coordinate space that defines an angle of view of the frame.

### Accessory Information

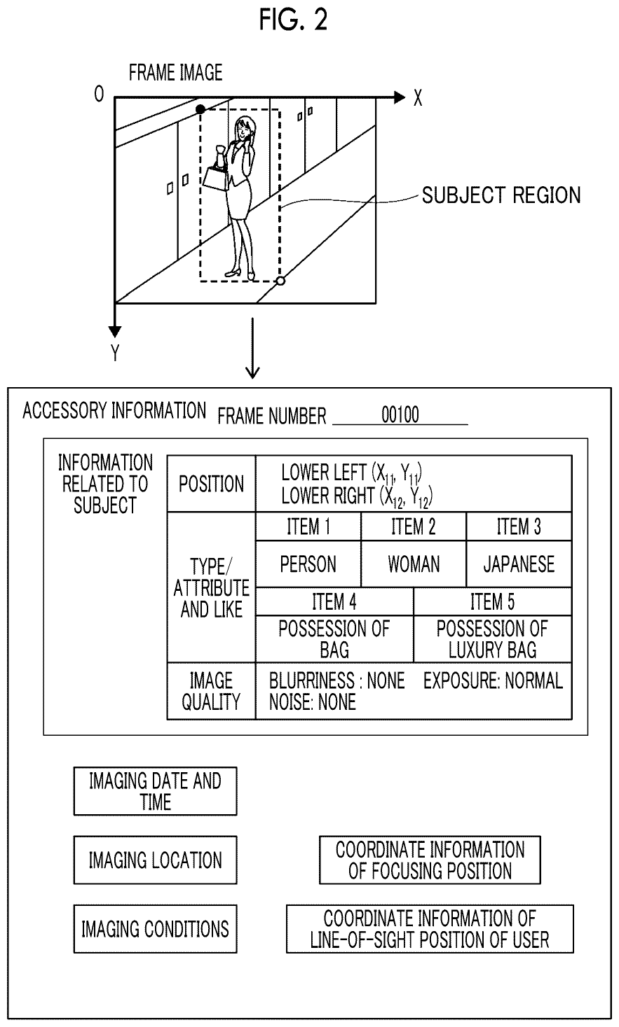

In each frame of the moving image data, a box region in which accessory information can be recorded is provided, and accessory information related to a subject in the frame can be recorded. Specifically, an item corresponding to the subject can be recorded as the accessory information related to the subject. In a case where the subject is classified into each viewpoint, items include an article and a category corresponding to the subject, and include, in an easy-to-understand manner, phrases (words) representing a type, a state, a property, a structure, an attribute, and other features of the subject. For example, in the case illustrated in FIG. 2, “person”, “woman”, “Japanese”, “possession of bag”, and “possession of luxury bag” correspond to the items.

In addition, the accessory information including two or more items may be added to one subject, or the accessory information including a plurality of items having different degrees of abstraction may be added to one subject. In addition, as the number of items of the accessory information added to one subject increases, or as the accessory information is more specific (detailed), an accuracy of the item of the accessory information for the subject becomes higher. Here, the accuracy is a concept representing a degree of detail (fineness) of the content of the subject that is described by the accessory information.

In addition, the accessory information including an item having a higher accuracy than the item may be added to the subject to which the accessory information including the item is added. In the case illustrated in FIG. 2, for example, the accessory information including an item of “woman” with higher accuracy is added to the subject to which the accessory information including an item of “person” is added. In addition, the accessory information including an item of “possession of luxury bag” with higher accuracy is added to the subject to which the accessory information including an item of “possession of bag” is added.

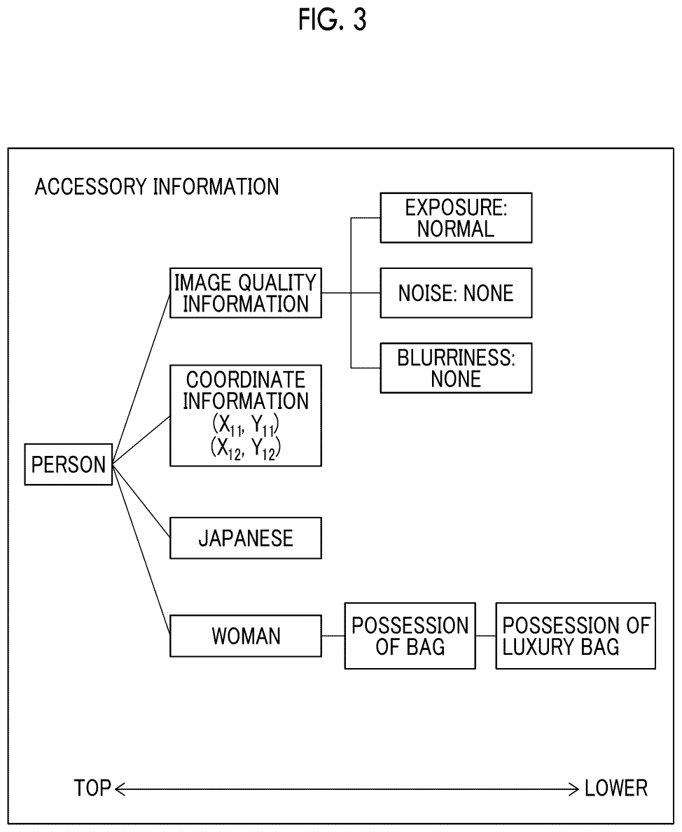

Note that, preferably, the accessory information is defined for each hierarchy as illustrated in FIG. 3.

In addition, the item of the subject may include an item that cannot be identified from the appearance of the subject, for example, the presence or absence of an abnormality such as a disease in a crop, or a quality such as a sugar content of a fruit. The item that cannot be identified from the appearance as described above can be determined from a feature amount of the subject in the image data. Specifically, a correspondence relationship between a feature amount of the subject and an attribute of the subject is trained in advance, and the attribute of the subject can be determined (estimated) from the feature amount of the subject in the image based on the correspondence relationship.

Note that the feature amount of the subject includes, for example, a resolution, a data amount, a degree of blurriness, and a degree of a shake of the subject in the frame, a size ratio of the frame to an angle of view, a position in the angle of view, a tint, or a combination of a plurality of these attributes. The feature amount can be calculated by applying a known image analysis technique and analyzing a subject region in an angle of view. In addition, the feature amount may be a value output by inputting a frame (image) to a mathematical model constructed by machine learning, and may be, for example, a one-dimensional vector value or multi-dimensional vector value. In addition, at least, any value that is uniquely output when one image is input can be used as a feature amount.

Further, in the box region, the accessory information indicating a position (coordinate position) of the subject in the angle of view and accessory information indicating a distance (depth) to the subject in a depth direction may be recorded. As illustrated in FIG. 2, the coordinates of the subject are coordinates of a point present on an edge of a region (hereinafter, a subject region) that surrounds a part or the whole of the subject in a two-dimensional coordinate space that defines the angle of view of the frame. A shape of the subject region is not particularly limited, and may be, for example, a substantially circular shape or a rectangular shape. The subject region may be extracted in a case where a user designates a certain range within the angle of view, or may be automatically extracted by using a known subject detection algorithm or the like.

In a case where the subject region is a rectangular region indicated by a broken line in FIG. 2, the position of the subject is specified by coordinates of two intersections (points indicated by a white circle and a black circle in FIG. 2) located at both ends of a diagonal line at an edge of the subject region. In this way, the position of the subject in the angle of view can be accurately specified by the coordinates of a plurality of points.

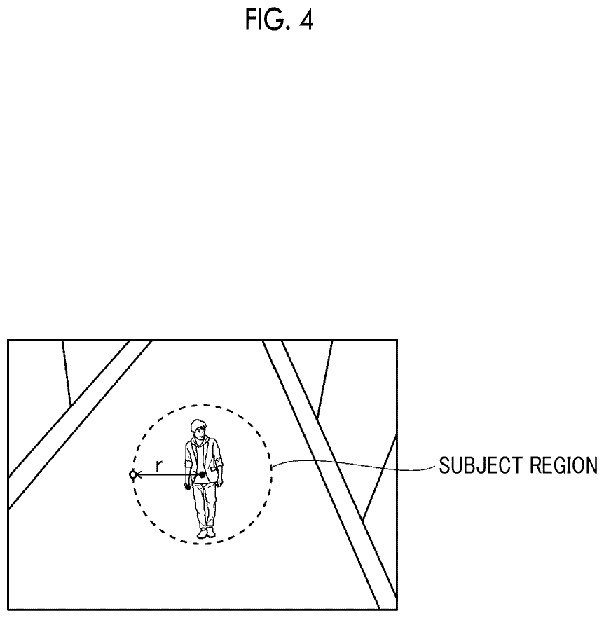

In addition, the subject region may be a region specified by the coordinates of a base point in the subject region and a distance from the base point. For example, in a case where the subject region has a circular shape as illustrated in FIG. 4, the subject region is specified by coordinates of a center (base point) of the subject region and a distance from the base point to an edge of the subject region (that is, a radius r). In this case, the coordinates of the center which is the base point and the radius which is the distance from the base point are the position information of the subject region. By using the base point in the subject region and the distance from the base point in this way, it is possible to accurately represent the position of the subject.

Note that the position of the subject region having a rectangular shape may be represented by the coordinates of the center of the region and the distance from the center in each coordinate axis direction.

In addition, accessory information (hereinafter, size information) indicating a size of the subject may be recorded in the box region. The size of the subject can be specified, for example, based on the position information of the subject, specifically, the position (coordinate position) of the subject in the angle of view, the depth of the subject, and the like.

Further, as illustrated in FIG. 2, accessory information indicating the image quality of the subject (hereinafter, also referred to as image quality information) may be recorded in the box region. The image quality is the image quality of the subject that is indicated by the data of the frame image, and includes, for example, a sense of resolution, noise, brightness, and the like of the subject. The sense of resolution includes the presence or absence of blurriness or a shake, a degree of blurriness or a shake, resolution, a grade or a rank corresponding to these factors, and the like. The noise includes an S/N ratio, the presence or absence of white noise, a grade or a rank corresponding to these factors, and the like. The brightness includes a brightness value, a score indicating the brightness, a grade or a rank corresponding to these factors, and the like. In addition, the brightness may include the presence or absence of an exposure abnormality, such as whiteout or blackout (whether or not the brightness exceeds a range that can be expressed by a gradation value). In addition, the image quality information may include an evaluation result (sensory evaluation result) in a case where the sense of resolution, the noise, the brightness, and the like are evaluated based on the human sense.

The moving image data in which the accessory information described above is recorded in the frame is used for various applications, and can be used, for example, for the purpose of creating training data for machine learning. Specifically, since the subject in the frame can be specified from the accessory information (specifically, the item of the accessory information), the moving image data is annotated (sorted) based on the accessory information recorded in the frame. The annotated moving image data and the data of the frame image of the annotated moving image data are used to create training data, and machine learning is performed by collecting training data required for machine learning.

### Basic Flow for recording Accessory Information

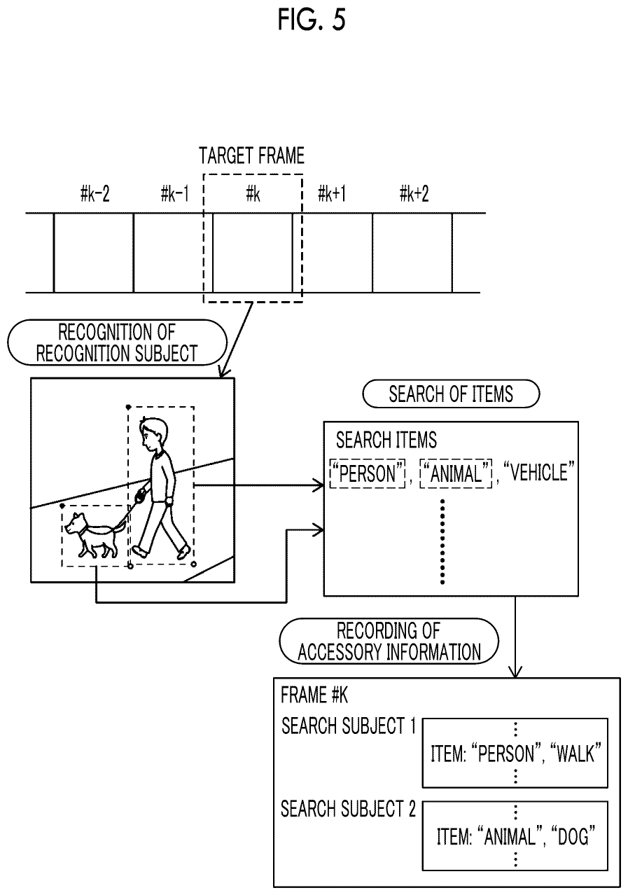

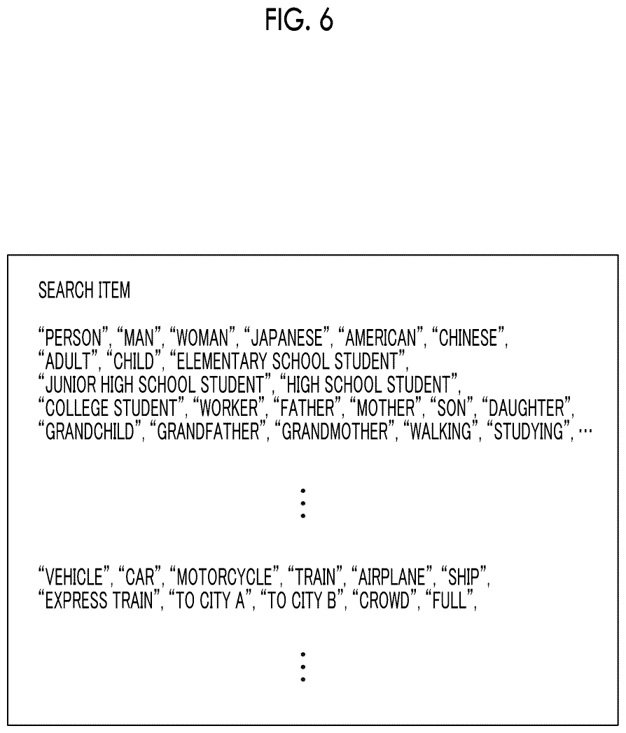

Hereinafter, a basic flow of recording the accessory information in the frame of the moving image data will be described with reference to FIG. 5 and FIG. 6.

In a case where the accessory information is recorded in the frame, first, as illustrated in FIG. 5, the subject (hereinafter, referred to as a recognition subject) in the frame is recognized. Specifically, a subject region within the angle of view of the frame is extracted, and a subject in the extracted region is recognized as a recognition subject. Note that, in a case where a plurality of subject regions are extracted in the frame, the same number of recognition subjects as the number of extracted regions are recognized.

Next, the recognition subject is set as a search subject. The search subject is a target subject for which a search step to be described later is to be executed. In a case where a plurality of recognition subjects are recognized, at least some of the plurality of recognition subjects are set as the search subjects.

Next, the accessory information that can be recorded for the search subject is searched for based on the search item. Note that the recording of the accessory information for the search subject is synonymous with the recording of the accessory information for the frame in which the search subject is present.

As illustrated in FIG. 6, the search items are a plurality of items (item groups) that are set as candidates of the accessory information. For example, in a case where the search subject is a person, an item of “person” is searched for from the search items. In addition, the search items include a plurality of items that change the accuracy (specifically, fineness and a degree of abstraction) in stages for a certain viewpoint (a theme and a category). For example, the search items include an item of “person”, and further include items representing gender, age, nationality, occupation, and the like as more detailed items related to “person”.

Further, an item corresponding to the search subject is searched for from the search items as the accessory information that can be recorded for the search subject. In this case, as the number of items to be searched for increases, or as the items to be searched for are more specific (detailed), the accuracy of the search is higher.

In addition, the accuracy of the search item, that is, the number of items included in the search items and fineness of the items included in the search items are variable, and can be changed after being set once. For example, after the accuracy of the search item is set according to a first search subject, the accuracy of the search item used in a case of searching for the accessory information for a second search subject can be changed according to the second search subject.

The accuracy of the search item may be set to be high according to the subject in the preceding frame. For example, whether or not a subject (first subject) in a certain frame is a person may be searched for, and a search item having a higher accuracy, such as gender, nationality, and age, may be set for the subject (the same subject as the first subject) in a subsequent frame.

Note that the method of searching for the accessory information that can be recorded for the search subject is not particularly limited. For example, a type, a property, a state, and the like of the subject may be estimated from the feature amount of the subject, and an item that matches or corresponds to the estimation result may be found from the search items. In addition, in a case where a plurality of search subjects are set, for each search subject, the accessory information that can be recorded for each search subject is searched for.

Next, based on the search result described above, the searched items (that is, some of the search items) are recorded in the frame in which the search subject is present as the accessory information. The recording of the accessory information in the frame means writing of the accessory information in the box region provided in the image data of the frame. Note that, in a case where the item corresponding to the search subject is not present in the search items, the accessory information indicating “no corresponding item” may be recorded in the frame in which the search subject is present.

In addition, in a case where a plurality of subjects are set as the search subjects, as illustrated in FIG. 5, for each subject, the accessory information (item) is searched for, and the searched accessory information (item) is recorded in the frame in association with the corresponding one subject. Note that the search of the accessory information (item) may not be executed for all of the plurality of subjects in the frame.

On the other hand, in a case where the accessory information is recorded in the frame of the moving image data by the above-described procedure, it is required to efficiently search for the accessory information that can be recorded for the search subject from the search items (lists).

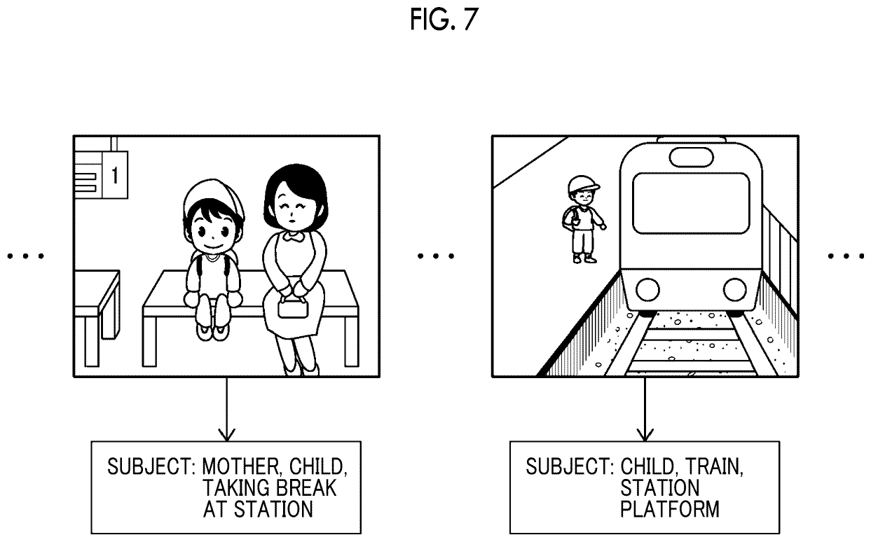

On the other hand, for example, as illustrated in FIG. 7, during the recording of the moving image data, the subject in the frame may be changed due to switching of the scene, a movement of the subject, or the like. In addition, a plurality of subjects different from each other may be present in the same frame. Further, of course, the accessory information that can be recorded for the subject (search subject) can be changed according to the subject.

Therefore, the search item that is a search range of the accessory information needs to be appropriately set according to the subject. For example, in a case where the search subject is “person” and in a case where the search subject is “scenery”, the accessory information (item) to be searched for is different. Therefore, it is necessary to set the search item in consideration of this point.

In addition, for an important subject (main subject), it is preferable to set a search item having a high accuracy, for example, a search item including a large number of items and detailed items, from a purpose of performing search with high accuracy.

In addition, it is difficult and inefficient to record all the corresponding items for the subjects in each frame of the plurality of frames of the moving image data. In consideration of the above points, it is necessary to appropriately set the search item.

Therefore, in the embodiment of the present invention, a recording device and a recording method to be described below are used from the viewpoint of appropriately recording the accessory information in the frame of the moving image data. In the following description, a configuration of a recording device according to the embodiment of the present invention and a flow of a recording method according to the embodiment of the present invention will be described.

### Configuration of Recording Device according to Embodiment of Present Invention

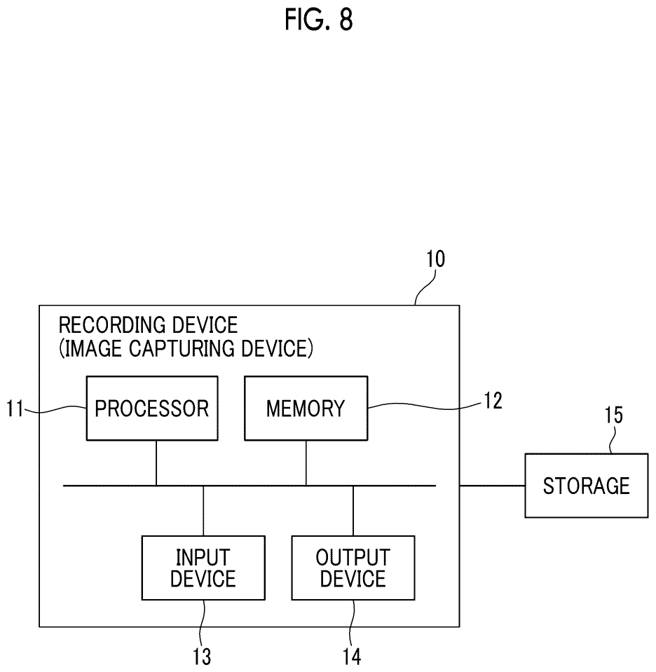

As illustrated in FIG. 8, a recording device (hereinafter, a recording device 10) according to the embodiment of the present invention is a computer comprising a processor 11 and a memory 12. The processor 11 is configured by using, for example, a central processing unit (CPU), a graphics processing unit (GPU), a digital signal processor (DSP), or a tensor processing unit (TPU). The memory 12 is configured by using, for example, a semiconductor memory, such as a read only memory (ROM) and a random access memory (RAM).

In addition, the recording device 10 comprises an input device 13 that receives a user operation, such as a touch panel and a cursor button, and an output device 14, such as a display and a speaker. The input device 13 may include a device that receives a voice input of the user. In this case, the recording device 10 may recognize the voice of the user, analyze the voice by morphological analysis or the like, and acquire the analysis result as the input information.

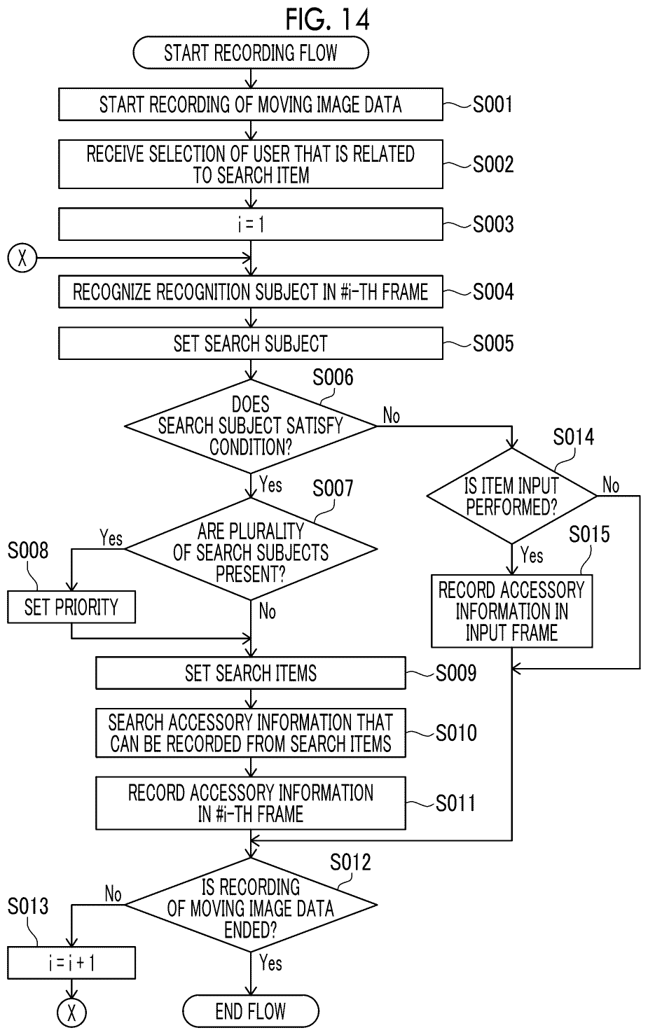

In addition, the memory 12 stores a program (hereinafter, a recording program) for recording the accessory information in the frame of the moving image data. The recording program is a program that causes the computer to execute each step (specifically, each step in a recording flow illustrated in FIG. 14) included in the recording method according to the embodiment of the present invention. The recording program may be acquired by being read from a computer-readable recording medium, or may be acquired by being downloaded through a communication network such as the Internet or an intranet.

In addition, the recording device 10 can freely access various kinds of data stored in a storage 15. The data stored in the storage 15 includes data required in a case where the recording device 10 records the accessory information, specifically, data of the search item described above.

Note that the storage 15 may be built in the recording device 10 or may be externally attached to the recording device 10, or may be configured with a network attached storage (NAS) or the like. Alternatively, the storage 15 may be an external device that can communicate with the recording device 10 through the Internet or a mobile communication network, such as an online storage.

In the embodiment of the present invention, the recording device 10 is configured to record moving image data, and is configured by, for example, a moving image capturing device that captures a moving image, such as a digital camera or a video camera. The configuration (particularly, the mechanical configuration) of the image capturing device constituting the recording device 10 is substantially the same as the configuration of a well-known device having a function of capturing a moving image. In addition, the image capturing device may have an autofocus (AF) function of automatically focusing on a predetermined position within an angle of view. Further, the image capturing device may have a function of specifying a focusing position, that is, an AF point during recording of the moving image data by using the AF function.

In addition, the image capturing device has a function of detecting a shake of an angle of view that is caused by hand shaking or the like and a shake of a subject that is caused by a movement of the subject. Here, the “shake” is an irregular and slow vibration (shaking), and is different from, for example, an intentional change in angle of view, specifically, an operation of quickly changing a direction of the image capturing device along a predetermined direction (specifically, a pan operation). Note that the shake of the subject can be detected by, for example, a known image analysis technique. The shake of the angle of view can be detected by, for example, a known shake detection device such as a gyro sensor.

In addition, the image capturing device may further comprise a finder, specifically, an electronic view finder or an optical view finder, through which a user (that is, a person who captures a moving image) looks at the subject during the recording of the moving image data. In this case, the image capturing device may have a function of detecting a position of a visual line and a position of a pupil of the user during recording of the moving image data and specifying the position of the visual line of the user. The position of the visual line of the user corresponds to an intersection position between the visual line of the user who looks at the subject through the finder and a display screen (not illustrated) in the finder.

In addition, the image capturing device may be provided with a known distance sensor such as an infrared sensor. In this case, the image capturing device can measure a distance (depth) in the depth direction for each subject within the angle of view.

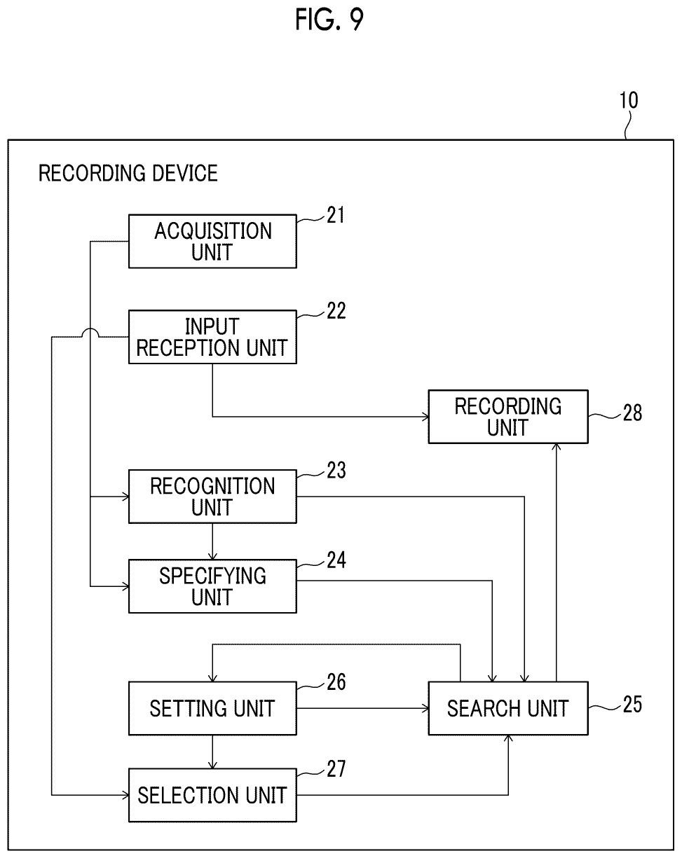

The function of the recording device 10, particularly, the function related to recording of the accessory information in the frame will be described with reference to FIG. 9. As illustrated in FIG. 9, the recording device 10 includes an acquisition unit 21, an input reception unit 22, a recognition unit 23, a specifying unit 24, a search unit 25, a setting unit 26, a selection unit 27, and a recording unit 28. These functional units are implemented by cooperation between the hardware device (the processor 11, the memory 12, the input device 13, and the output device 14) provided in the recording device 10 and the software including the recording program.

Hereinafter, each of the functional units will be described.

### Acquisition Unit

The acquisition unit 21 acquires the moving image data including the plurality of frames. Specifically, the acquisition unit 21 acquires the moving image data by recording a frame (frame image) at a constant frame rate within an angle of view of the image capturing device constituting the recording device 10.

### Input Reception Unit

The input reception unit 22 executes a receiving step, and receives, in the receiving step, a user operation performed in association with recording of the accessory information in the frame. The user operation received by the input reception unit 22 includes an input of the user that is related to an item of the accessory information (hereinafter, referred to as an item input). The item input is an input operation performed to record the accessory information corresponding to the item which is input by the user.

Specifically, for example, in the input device 13 of the recording device 10, a predetermined item (accessory information) is assigned to a button (for example, one function key) selected by the user. An operation of pressing the button is item input, and an item assigned to the button corresponds to the input item. Here, the item input is not limited to the operation, and may be, for example, voice input performed by the user who pronounces a predetermined item.

### Recognition Unit

The recognition unit 23 executes a recognition step to recognize the plurality of recognition subjects in the plurality of frames included in the moving image data in the recognition step. Specifically, in the recognition step, the subject region in the angle of view of each frame is extracted, and the subject in the extracted subject region is specified.

Here, the “plurality of recognition subjects in the plurality of frames” includes a set of subjects obtained by collecting the subjects to be recognized in each of the plurality of frames and a plurality of subjects to be recognized in one frame.

Note that a form in which the plurality of recognition subjects in the plurality of frames are recognized may include a form in which a frame in which the recognition subject is not recognized is present among the plurality of frames.

### Specifying Unit

The specifying unit 24 specifies the position, the size, and the image quality of the recognition subject in the frame, the focusing position (AF point), the visual line position of the user in a case of using the finder, and the like for each frame.

The position of the recognition subject in the frame is a position (coordinate) of the subject region in the angle of view, a position (depth) of the subject region in the depth direction, or a combination thereof. The position of the subject region (coordinate position in the two-dimensional space) can be specified by the above-described procedure, and the depth can be measured by a known distance sensor such as an infrared sensor.

The size of the recognition subject in the frame can be specified from the position of the subject region in the angle of view and the depth of the recognition subject.

The image quality of the recognition subject in the frame is blurriness, a shake, the presence or absence of exposure abnormality, a combination of these, or the like. The image quality of the subject can be specified by an image analysis function, a sensor, or the like provided in the image capturing device constituting the recording device 10.

The focusing position and the visual line position of the user in a case where the finder is used are positions that are set when recording of the moving image data, and can be specified by an image analysis function or a sensor or the like provided in the image capturing device constituting the recording device 10.

Note that the articles specified for each frame by the specifying unit 24 are recorded in the box region in the data structure of each frame.

Further, the specifying unit 24 can specify the presence or absence of a movement of the recognition subject, a movement direction of the recognition subject in a case where the recognition subject moves, and the like, for each of the recognition subjects from the plurality of frames including a frame in which the recognition subject is present.

### Search Unit

The search unit 25 executes a search step for the search subject. The search subject is some or all of the plurality of recognition subjects recognized by the recognition unit 23. A method of determining the search subject from the recognition subjects is not particularly limited. For example, the search subject may be determined according to a predetermined criterion, or the search subject may be determined based on selection of the user.

In addition, in the embodiment of the present invention, the search unit 25 executes the search step for the search subject selected by at least one condition (corresponding to a predetermined condition) of a first condition or a second condition related to the execution of the search step. By setting the condition for the search subject on which the search step is to be executed in this way, the target subject to be searched for can be limited. As a result, a load on the search step can be reduced.

The first condition is a condition based on image quality information or size information of the search subject in the frame. The image quality information and the size information are pieces of information indicating the image quality (specifically, the presence or absence of blurriness, a shake, and exposure abnormality) and the size of the recognition subject corresponding to the search subject, the image quality and the size being specified by the specifying unit 24. Examples of the search subject that satisfies the first condition include a search subject in which a degree of blurriness or a shake is lower than a predetermined level and a search subject of which the size is smaller than a predetermined size. Here, the predetermined level is, for example, a limit value of image quality that can be allowed to be used as training data for machine learning (specifically, scene learning or the like).

By providing the first condition, the image quality of the search subject on which the search step is to be executed is secured at a certain level or higher. Therefore, in a case where the search step is executed for the search subject satisfying the first condition, a more accurate (more reliable) search result can be obtained.

The second condition is a condition based on the focusing position (AF point) that is set when recording of the moving image data or the visual line position of the user during the recording of the moving image data. The focusing position and the visual line position of the user are the positions specified by the specifying unit 24 for the frame in which the search subject is present. The search subject that satisfies the second condition is, for example, a search subject that is present within a predetermined distance from the focusing position or the visual line position of the user in the angle of view.

Note that, in a case of determining whether or not the search subject satisfies the second condition, the depth of the search subject (specifically, the depth measured by the specifying unit 24 for the recognition subject corresponding to the search subject) may be considered.

By providing the second condition, the search step can be executed, for example, for a main search subject or a search subject of interest to the user. That is, in a case where the search step is executed for the search subject satisfying the second condition, it is possible to record the accessory information for the subject that is important to the user.

The first condition or the second condition may be used to set a priority in a case where a search subject for executing the search step is selected from the plurality of subjects. For example, in a case where there is an upper limit on the number of search subjects, a score corresponding to whether or not each of the plurality of recognition subjects satisfies the first condition or the second condition may be calculated, and a subject having a higher score may be set as the search subject.

In the search step, the search unit 25 searches for the accessory information that can be recorded for the search subject based on the search item, specifically, searches for the item corresponding to the search subject from the search items. The search items used in the search step are set by the setting unit 26, and are selected by the selection unit 27.

In addition, in the embodiment of the present invention, an interval between the frames for which the search unit 25 executes the search step (an execution rate of the search step) can be changed according to the search item used in the search step. For example, in a normal case, the search step is executed for each frame or for several frames. On the other hand, in a case where a specific search item is used, the interval between the frames in which the search step is to be executed may be further widened, in other words, the execution rate of the search step may be lowered than the execution rate in a normal case.

### Setting Unit

The setting unit 26 executes a setting step to set the search item according to the search subject on which the search item is to be executed (that is, the search subject satisfying the first condition or the second condition) in the setting step. In addition, in the setting step in a case where a plurality of search subjects are present, the setting unit 26 sets the search items different from each other for each search subject.

Specifically, a plurality of search items (search item groups) are prepared in advance, and a feature amount of the subject is associated with each search item. The setting unit 26 sets the search item to be used in the search step for the search subject by selecting the search item corresponding to the feature amount of the search subject on which the search item is to be executed from the search item groups.

Note that, as described above, the feature amount of the subject can be calculated by analyzing the subject region in the angle of view by a known image analysis technique, or can be output by inputting the image to a mathematical model constructed by machine learning.

In addition, a form in which the search items different from each other are set for each search subject may include a form in which search subjects for which the same search items are set are present among the plurality of search subjects. In addition, a form in which the search items different from each other are set may include, for example, a form in which some of the items included in the search items are missing (absent).

In addition, in the embodiment of the present invention, the setting unit 26 sets, for each search subject, a priority for the search subject. The priority is determined according to a category, a display size, a position in an angle of view, a focusing position, a distance from a visual line position of the user, a depth, the presence or absence of a movement, the presence or absence of a state change, and the like of the search subject. Specifically, in a case where the search subject is a person, a higher priority is set than in a case where the search subject is the background. In addition, a higher priority is set for the search subject that has movement than for the search subject that has no movement. In addition, the priority may be set by the user.

Note that a form in which the priority is set for each search subject may include a form in which a search subject for which the priority is not set is present among the search subjects.

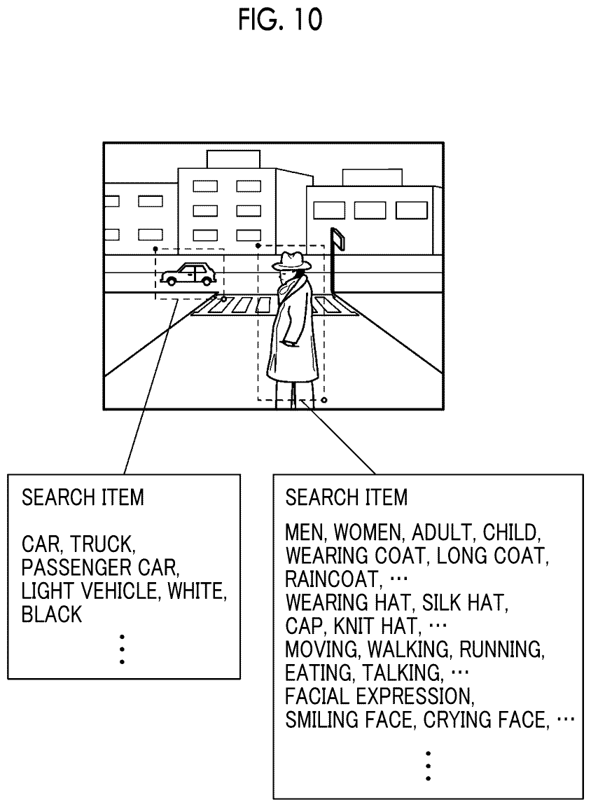

In addition, in the setting step, the accuracy of the search item to be set for the search subject having a higher priority is set to be higher than the accuracy of the search item to be set for the search subject having a lower priority. As described with reference to FIG. 10, in the search item for the search subject (a person in FIG. 10) having a higher priority, the number of items is larger than the number of items included in the search item for the search subject (a car in FIG. 10) having a lower priority, and more detailed (specific) items are included.

In addition, in the embodiment of the present invention, in a case where the search item is set for the search subject in each frame in the setting step, the accuracy of the search item is set according to the result of the search step for the previous frame (that is, the past frame).

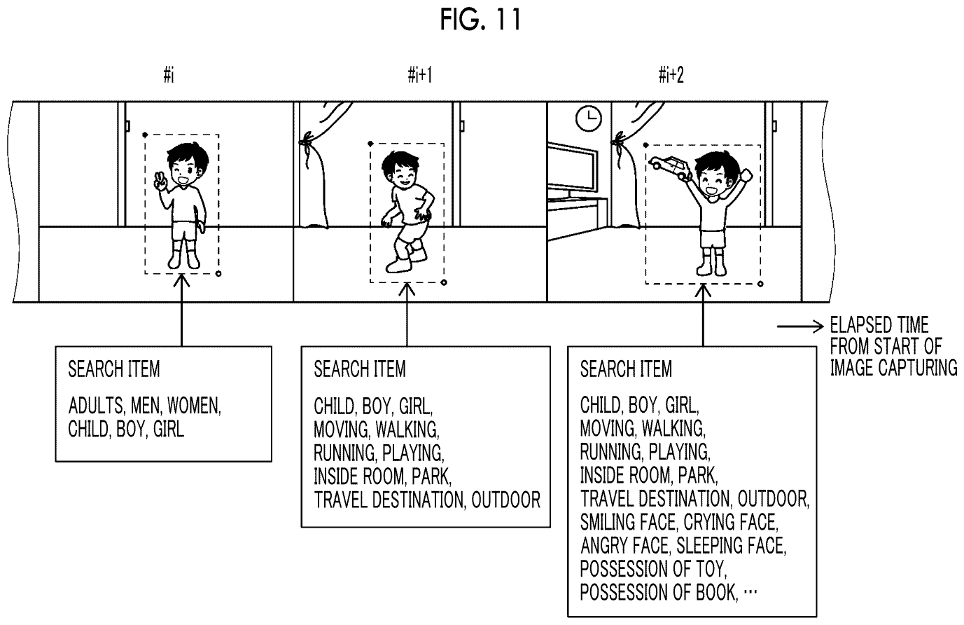

As described with reference to FIG. 11, it is assumed that the search subject in a first frame among a plurality of frames included in the moving image data is present in a second frame before the first frame. In FIG. 11, for example, the search subject “child” is present in three consecutive frames (#i to #i+2). Here, in two frames before and after, the later frame corresponds to the first frame, and the earlier frame corresponds to the second frame. In this case, in the setting step, the accuracy of the search item that is set for the search subject in the first frame is set to be higher than the accuracy of the search item that is set for the search subject in the second frame. For example, as illustrated in FIG. 11, in the search item for the search subject (child) in the (#i+1)-th frame, the number of items is larger than the number of items included in the search item for the same search subject in the #i-th frame, and more detailed items are included. Similarly, the search item for the search subject in the (#i+2)-th frame has a higher accuracy than the search item for the same search subject in the (#i+1)-th frame.

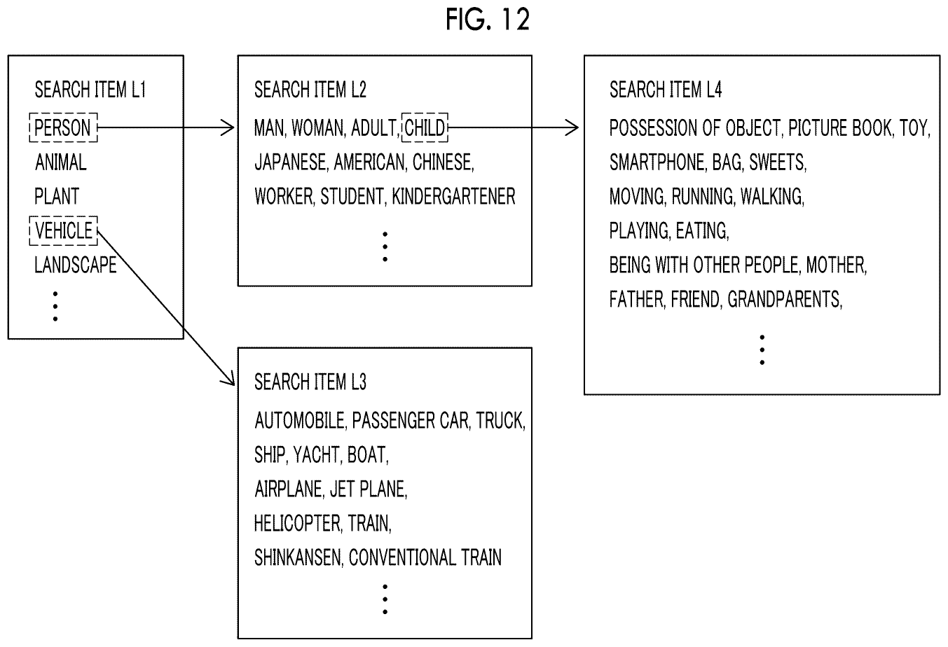

In addition, in a case where a description is given with another example, the setting unit 26 may set the search item that defines a rough classification of the subject, for example, the search item L1 in FIG. 12 at the start of the recording of the moving image data and immediately after the imaging scene is switched. In this case, for example, it is assumed that, for the search subject in the frame, the item of “person” is searched for from the search item L1. In this case, in the next frame, the search item L2 that has a higher accuracy and is related to the person is set. Similarly, in a case where the item of the search subject “vehicle” in the frame is searched for from the search item L1, in the next frame, the search item L3 that has a higher accuracy and is related to the vehicle is set. Further, it is assumed that, for the search subject in a certain frame, the item “child” is searched for from the search item L2. In this case, in the next frame, the search item L4 that has a higher accuracy and is related to the child is set. (Selection Unit)

The selection unit 27 receives a selection operation of the user that is related to the search item, and selects (selection) the search item selected by the user from the search item groups, based on the received selection operation. The selection of the search item by the selection unit 27 is performed, for example, in a stage before the recording of the accessory information is started.

In addition, the search item selected by the selection unit 27 is preferentially used in the search step by the search unit 25. Specifically, in a case of searching for the accessory information (item) that can be recorded for the search subject in each frame, the search unit 25 uses the search item that is set according to the search subject by the setting unit 26. In this case, for example, in a case where the user selects the search item related to the train in advance via the selection unit 27, the search unit 25 executes the search step by using the search item related to the selected train together with the search item that is set by the setting unit 26 or instead of the search item that is set. Thereby, in a case where the train as the subject appears in the frame, the accessory information (item) can be searched for from the search items related to the train by using the train as the search subject.

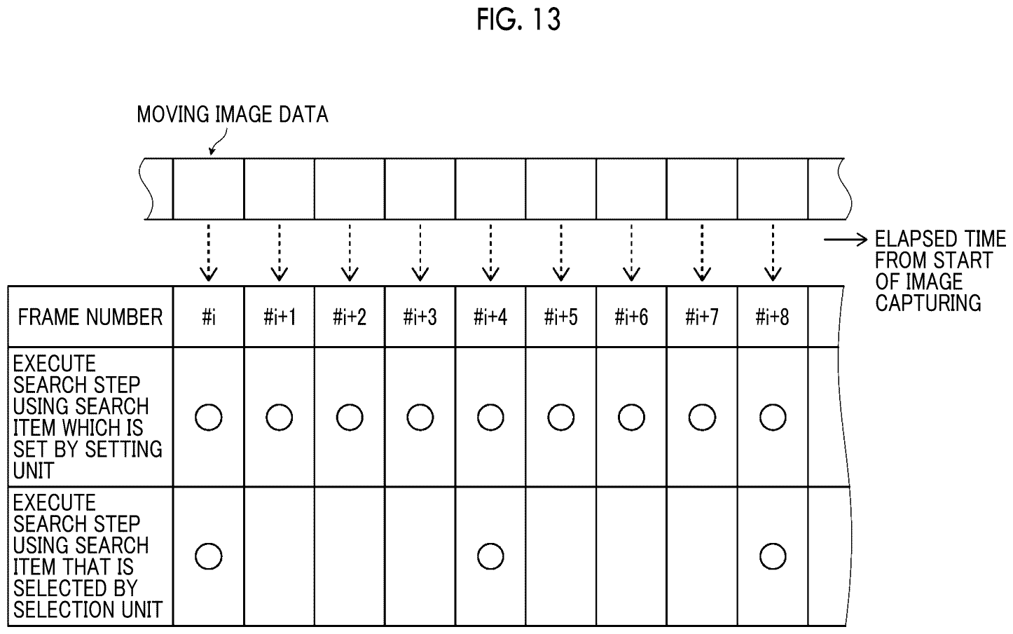

In addition, as illustrated in FIG. 13, an execution rate of the search step using the search item that is selected by the selection unit 27 may be lower than an execution rate of the search step using the search item that is set by the setting unit 26. Thereby, for example, the search step using the search item that is selected by the user can be executed at a relatively low execution rate such as once in several frames.

### Recording Unit

The recording unit 28 executes a recording step to record at least some of the search items as the accessory information based on a result of the search step in the recording step. Specifically, the recording unit 28 records, for the search subject, the item that is searched for in the search step, in the box region in the data structure of the frame in which the search subject is present.

In addition, in the recording step, the recording unit 28 records, as the accessory information, the coordinate position of the focusing position or the visual line position, in the frame in which the focusing position or the visual line position of the user is specified by the specifying unit 24. Thereby, the accessory information recorded for the search subject in each frame can be associated with the focusing position or the visual line position in each frame. Thereby, for example, in a case where machine learning or the like for scene recognition is performed using the moving image data, the accessory information that is recorded for the search subject in each frame can be used in association with the focusing position or the visual line position in the frame.

In addition, in a case where the input reception unit 22 executes a receiving step to receive the item input, the recording unit 28 executes the recording step for the input frame. The input frame is a frame corresponding to the item input among the plurality of frames included in the moving image data, and is specifically a frame on which recording is performed at a timing when the item input is received. In addition, the input frame may include frames before or after a timing at which the item input is received (for example, several frames before or after the frame at a timing at which the input is received).

In addition, in the receiving step, an item of the accessory information that is different from the search item which is set by the setting unit 26 can be received. In other words, in the item input, the user can designate an item unique to the user that is not included in the normal search items. In addition, in the recording step for the input frame, the accessory information corresponding to the item which is input by the user is recorded. For example, in a case where a function key for item input is pressed, the recording unit 28 records the accessory information corresponding to the item assigned in advance to the function key, in the input frame. Alternatively, in a case where the user inputs a new item with a voice for item input, the accessory information corresponding to the item obtained by voice input is recorded in the input frame.

### Recording Flow according to Embodiment of Present Invention

Next, a recording flow using the recording device 10 will be described. In a recording flow to be described below, the recording method according to the embodiment of the present invention is used. That is, each step in the recording flow to be described below corresponds to a component of the recording method according to the embodiment of the present invention.

Note that the following flow is merely an example, and within a range not departing from the gist of the present invention, some steps in the flow may be deleted, new steps may be added to the flow, or the execution order of two steps in the flow may be exchanged.

The recording flow by the recording device 10 proceeds according to the flows illustrated in FIG. 14, and each step in the recording flow is executed by the processor 11 provided in the recording device 10. That is, in each step in the recording flow, the processor 11 executes processing corresponding to each step in data processing defined in the recording program. Specifically, the processor 11 executes recognition processing in the recognition step, search processing in the search step, setting processing in the setting step, and recording processing in the recording step.

The recording flow is executed by being triggered by a start of the recording of the moving image data (S001). In the recording flow, in a case where the user selects the search item, the selection operation is received (S002). Note that this step S002 is omitted in a case where there is no selection operation by the user.

In the recording flow, the recognition step, the setting step, the search step, and the recording step are executed for the plurality of frames included in the moving image data. That is, the processor 11 recognizes the plurality of recognition subjects in the plurality of frames, and searches for the accessory information that can be recorded for the search subjects, which are some or all of the plurality of recognition subjects, based on the search items. In addition, in a case where a plurality of search subjects are present, the processor 11 sets the search items different from each other for each search subject. In addition, the processor 11 records at least some of the search items as the accessory information in each frame based on the search result.

Note that the search step is not limited to being executed after the recognition step and may be executed at the same timing as the recognition step. In addition, the plurality of frames may include a frame in which the recognition step is not executed. In addition, in a case of setting the search items different from each other for each search subject, the search subjects for which the same search items are set may be present.

The recording flow will be described in more detail. First, i is set to 1 for the frame number #i (i is a natural number), and the recognition subject in the #i-th frame is recognized (S003, S004).

Thereafter, some or all of the recognition subjects in the #i-th frame are set as the search subject, and it is determined whether or not the search subject satisfies the first condition or the second condition (S005, S006). Specifically, it is determined whether or not the search step can be executed for the search subject, based on the image quality information indicating a degree of blurriness and a shake of the search subject, the presence or absence of exposure abnormality, and the like. Alternatively, it is determined whether or not the search step can be executed for the search subject based on a position relationship between the focusing position or the visual line position and the search subject.

Note that, in step S006, the first condition or the second condition is used for the search subject that is set. On the other hand, in a case where the search subject is set in step S005, the first condition or the second condition may be used as a condition for selecting the search subject from the recognition subjects.

In addition, in each frame, in a case where a plurality of search subjects satisfying the first condition or the second condition are present, the priority for the search subject is set for each search subject (S007, S008). In this case, the plurality of search subjects may include a search subject for which the priority is not set.

Next, the search item is set according to the search subject that is determined as a search subject satisfying the first condition or the second condition (S009). In a case where a plurality of search subjects (specifically, search subjects satisfying the first condition or the second condition) are present in the #i-th frame, in step S009, the search item is set according to the priority that is set in step S008. Specifically, for the search subject having a higher priority, the search item having a higher accuracy than the search item that is set for the search subject having a lower priority is set.

Next, the accessory information (item) that can be recorded for the search subject satisfying the first condition or the second condition is searched for based on the search item which is set in step S009 (S010). In a case where a plurality of search subjects (specifically, search subjects satisfying the first condition or the second condition) are present in the #i-th frame, in step S010, the accessory information for each search subject is searched for from the search items that are set according to the priority of each search subject.

In addition, in a case where the selection of the user that is related to the search item is received in step S002, the accessory information for the search subject is searched for based on the search item selected by the user together with the search item that is set in step S009.

Thereafter, the accessory information (item) that is searched for in S010 is recorded in the #i-th frame (S011). In a case where, for the plurality of search subjects, the accessory information is searched for in step S010, in step S011, the accessory information for the plurality of search subjects is recorded in the #i-th frame.

In addition, in a case where the focusing position or the visual line position of the user is specified in the #i-th frame, coordinate information of the position is recorded in the #i-th frame as the accessory information.

Next, it is determined whether or not the recording of the moving image data is ended (S012). In a case where the recording is not ended, i is incremented (S013). Then, the process returns to step S004, and a series of steps of S004 and subsequent steps are repeated. Procedure of step S004 to step S011 to be executed for the #i-th frame in a case where i is equal to or larger than 2 is substantially the same as the above-described procedure.

On the other hand, in step S009 at the second time and subsequent times, the search item, which has the accuracy corresponding to the result of the search step for the previous frame (specifically, the (#i−1)-th frame), is set. More specifically, in a case where the search subject in the #i-th frame is common to the search subject in the (#i−1)-th frame, the accuracy of the search item for the search subject in the #i-th frame is set to be higher than the accuracy of the search item for the search subject in the (#i−1)-th frame. By gradually increasing the accuracy of the search item according to the transition of the frame in this way, for example, for the search subject appearing in two or more consecutive frames, more detailed information can be recorded as the accessory information, as the frame is later.

Note that, in a case where the subject in the frame is replaced due to switching or the like of the scene, the search item may be returned to the search item having the initial accuracy (for example, the search item including a roughly-classified item).

In addition, during the recording of the moving image data, the user can perform item input at any timing. In a case where the item input is performed, the item input is received, and the accessory information corresponding to the item which is input by the user is recorded in the input frame (S014, S015). Thereby, the item which is input by the user, that is, the item of the accessory information that is different from the search item which is set in step S009 can be received, and the accessory information can be recorded in the input frame. As a result, it is possible to record the item which is designated by the user, for example, a special item such as a technical term, as the accessory information.

In addition, the recording flow is ended when the recording of the moving image data is ended.

As described above, in the recording flow according to the embodiment of the present invention, the search item to be used in a case of searching for the accessory information that can be recorded for the search subject is set for each search subject. Thereby, it is possible to appropriately and efficiently record the accessory information corresponding to the subject (strictly speaking, the search subject) in the frame for each frame in the moving image data.

Specifically, since the search item is set for each search subject, for example, in a case where the subject in the frame is changed due to switching or the like of the scene, the search item is set according to the changed subject. Thereby, even after the scene is switched, it is possible to appropriately search for the accessory information (item) that can be recorded for the search subject from the search items.

In addition, in the embodiment of the present invention, in a case where a plurality of search subjects are present, the priority is set for each of the plurality of search subjects, and the search item having a higher accuracy is set for the search subject having higher priority. Thereby, for the subject that is more important to the user, more detailed information (item) can be searched for, and the searched information (item) can be recorded as the accessory information.

In addition, in the embodiment of the present invention, in the search step, the search item selected by the user can be used. Thereby, it is possible to search for the accessory information (item) that can be recorded for the search subject by using the search item selected by the user together with the search item which is set by the recording device 10 (that is, the item which is automatically set). As a result, it is easy to reflect the user's intention and the like in searching of the accessory information, and a recording method that is more preferable for the user is realized.

In addition, in the embodiment of the present invention, a range in which the search step is to be executed is limited. Specifically, the search step is executed only for the search subject that satisfies a predetermined condition (specifically, the first condition or the second condition) among the search subjects. By limiting the search subject on which the search step is to be executed in this way, it is possible to reduce a load on the search step. Further, the number of search subjects for which the accessory information is to be recorded is limited, and thus, it is possible to further reduce a storage capacity of the moving image data including the accessory information.

### Other Embodiments

The embodiment described above is a specific example for easily understanding the recording method, the recording device, and the program according to the embodiment of the present invention, and is merely an example. Other embodiments can also be considered. (Search Subject on which Search Step is to be executed)

In the embodiment described above, the search step is not executed for the search subject in which blurriness or a shake exceeds the predetermined level. Here, in a case where the search subject is a main subject and a subject around the main subject, even though slight blurriness or a slight shake occurs, the search step may be executed for the search subject. In this case, the accuracy of the search item to be used in the search step may be changed according to a degree of blurriness and a shake. As the degree of blurriness and the shake is larger, the accuracy of the search item may be lowered. In addition, by comprehensively determining the depth of the search subject and the blurriness or the shake of the search subject, whether or not the search step is executed for the search subject may be determined.

In addition, the search subject on which the search step is to be executed may be designated by the user. That is, the search step may be executed for the search subject designated by the user among the plurality of search subjects, and the accessory information may be recorded based on the search result.

### Device/Equipment Included in Recording Device According to Present Invention

In the embodiment described above, the recording device according to the embodiment of the present invention is configured with a moving image capturing device (that is, a device that records the moving image data). On the other hand, the present invention is not limited thereto. The recording device according to the embodiment of the present invention may be configured with a device other than the image capturing device, for example, an editing device that acquires moving image data obtained by capturing a moving image from the image capturing device and performs data editing.

### Execution Time of Recognition Step, Search Step, Setting Step, and Recording Step

In the embodiment described above, the recognition step, the search step, the setting step, and the recording step are executed for the frame in the moving image data while recording the moving image data. Here, the present invention is not limited thereto, and the series of steps described above may be executed after the recording of the moving image data is ended.

### Modification Example of Data for which Accessory Information is stored

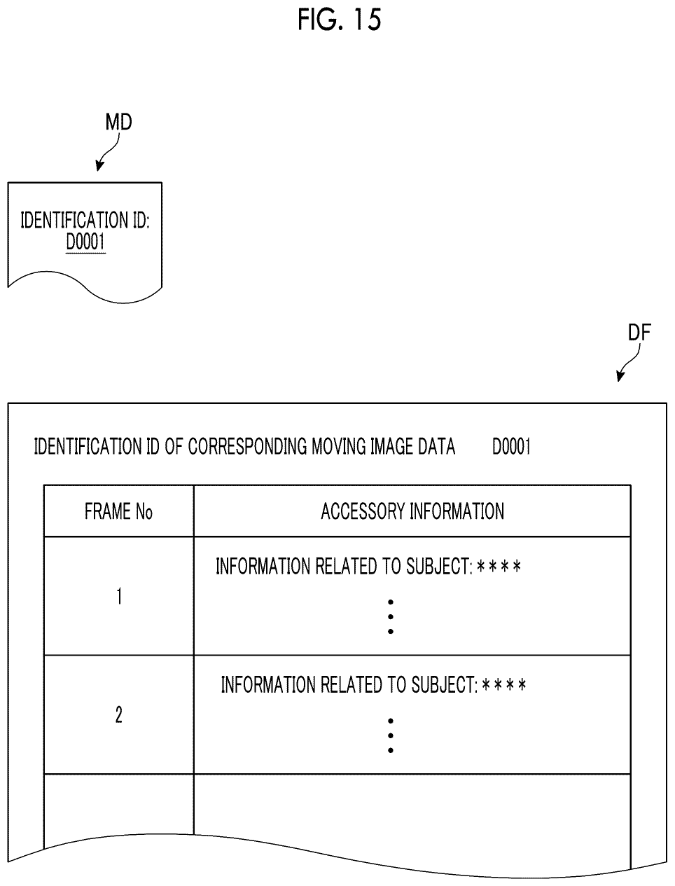

In the embodiment described above, the accessory information for the subject in the frame is stored in a part of the moving image data (specifically, a box region in a data structure of the frame). On the other hand, the present invention is not limited thereto. As illustrated in FIG. 15, the accessory information may be stored in a data file different from the moving image data. In this case, a data file in which the accessory information is stored (hereinafter, an accessory information file DF) is associated with the moving image data MD including the frame to which the accessory information is added. Specifically, the accessory information includes an identification ID of the moving image data. In addition, as illustrated in FIG. 15, in the accessory information file DF, the number of the frame to which the accessory information is added and the accessory information related to the subject in the frame are stored for each frame.

By storing the accessory information in a data file different from the moving image data as described above, it is possible to appropriately record the accessory information in the frame of the moving image data while preventing an increase in capacity of the moving image data.

Note that a form in which the accessory information is recorded in the accessory information file DF for each frame may include a form in which the plurality of frames included in the moving image data include a frame in which the accessory information is not described.

### Application to Image Data

In the embodiment described above, a case where the accessory information is recorded in the frame of the moving image data including the plurality of frames has been described as an example. The present invention can also be applied to a case where the accessory information is recorded in the image data including still image data. That is, the recording method according to the embodiment of the present invention is a recording method of recording the accessory information in the moving image data, and comprises the recognition step, the search step, the recording step, and the setting step. In addition, in a case where the image data is still image data, in the recognition step, the plurality of recognition subjects in the image data are recognized.

### Configuration of Processor

In addition, the processor provided in the recording device according to the embodiment of the present invention includes various processors. Examples of the various processors include a CPU that is a general-purpose processor that executes software (program) and functions as various processing units.

Moreover, various processors include a programmable logic device (PLD), which is a processor of which a circuit configuration can be changed after manufacturing, such as a field programmable gate array (FPGA).

Furthermore, the various processors include a dedicated electric circuit that is a processor having a circuit configuration specially designed for executing a specific process, such as an application specific integrated circuit (ASIC).

In addition, one functional unit included in the recording device according to the embodiment of the present invention may be configured by one of the various processors described above. Alternatively, one functional unit included in the recording device according to the embodiment of the present invention may be configured by a combination of two or more processors of the same type or different types, for example, a combination of a plurality of FPGAs or a combination of an FPGA and a CPU.

In addition, the plurality of functional units included in the recording device according to the embodiment of the present invention may be configured by one of the various processors, or two or more of the plurality of functional units may be configured by one processor.

In addition, as in the above-described embodiment, one processor may be configured of a combination of one or more CPUs and software, and the processor may function as the plurality of functional units.

In addition, for example, as typified by a system on chip (SoC) or the like, a form may be adopted in which a processor that realizes the functions of the entire system including the plurality of functional units in the recording device according to the embodiment of the present invention with one integrated circuit (IC) chip is used. Moreover, a hardware configuration of the various processors described above may be an electric circuit (circuitry) in which circuit elements, such as semiconductor elements, are combined.

### EXPLANATION OF REFERENCES

10: recording device
11: processor
12: memory
13: input device
14: output device
15: storage
21: acquisition unit
22: input reception unit
23: recognition unit
24: specifying unit
25: search unit
26: setting unit
27: selection unit
28: recording unit
DF: accessory information file
MD: moving image data

What is claimed is:

1. A recording method of recording accessory information in a frame of moving image data including a plurality of frames, the recording method comprising:
a recognition step of recognizing a plurality of recognition subjects in the plurality of frames;
a search step of searching for the accessory information which is able to be recorded for search subjects based on search items, the search subjects being at least some of the plurality of recognition subjects;
a setting step of setting the search items different from each other for each of the search subjects in a case where a plurality of the search subjects are present; and
a recording step of recording at least some of the search items as the accessory information based on a result of the search step.

2. The recording method according to claim 1,
wherein the search step is executed for the search subject selected by a predetermined condition.

3. The recording method according to claim 2,
wherein the condition is a condition based on image quality information or size information of the search subject in the frame.

4. The recording method according to claim 2,
wherein the condition is a condition based on a focusing position which is set by a recording device that records the moving image data or a visual line position of a user during recording of the moving image data.

5. The recording method according to claim 4,
wherein, in the recording step, coordinate information of the focusing position or the visual line position is recorded in the frame as the accessory information.

6. The recording method according to claim 1,
wherein, in the search step, the search item selected by a user is used.

7. The recording method according to claim 1,
wherein, in the setting step, priorities for the search subjects are set for each of the search subjects, and
an accuracy of the search item which is set for the search subject having a higher priority is higher than an accuracy of the search item which is set for the search subject having a lower priority.

8. The recording method according to claim 1,
wherein, in the setting step, an accuracy of the search item is set according to a result of the search step that is executed in the past.

9. The recording method according to claim 8,
wherein, in a case where the search subject in a first frame is present in a second frame before the first frame among the plurality of frames, in the setting step, the accuracy of the search item that is set for the search subject in the first frame is set to be higher than the accuracy of the search item that is set for the search subject in the second frame.

10. The recording method according to claim 1, further comprising:
a receiving step of receiving an input of a user that is related to an item of the accessory information,
wherein the recording step is executed to record the accessory information corresponding to the input item in an input frame corresponding to the input of the user, among the plurality of frames.

11. The recording method according to claim 10,
wherein, in the receiving step, an item of the accessory information is able to be received, the item being different from the search item which is set in the setting step.

12. The recording method according to claim 1,
wherein the accessory information is stored in a data file different from the moving image data.

13. A recording device that records accessory information in a frame of moving image data including a plurality of frames, the recording device comprising:
a processor,
wherein the processor is configured to execute:
recognition processing of recognizing a plurality of recognition subjects in the plurality of frames;
search processing of searching for the accessory information which is able to be recorded for search subjects based on search items, the search subjects being at least some of the plurality of recognition subjects;
setting processing of setting the search items different from each other for each of the search subjects in a case where a plurality of the search subjects are present; and
recording processing of recording at least some of the search items as the accessory information based on a result of the search processing.

14. A program causing a computer to execute each of the recognition step, the search step, the setting step, and the recording step included in the recording method according to claim 1.

15. A recording method of recording accessory information in moving image data, the recording method comprising:
a recognition step of recognizing a plurality of recognition subjects in the image data;
a search step of searching for the accessory information which is able to be recorded for search subjects based on search items, the search subjects being at least some of the plurality of recognition subjects;
a setting step of setting the search items different from each other for each of the search subjects in a case where a plurality of the search subjects are present; and
a recording step of recording at least some of the search items as the accessory information based on a result of the search step.
